(19) United States
(12) Patent Application Publication
(10) Pub. No.: US 2026/0340484 A1
(43) Pub. Date: Oct. 29, 2026

(54) MULTI-TENANT CLOUD-BASED SYSTEM

(71) Applicant: DevRev, Inc., Palo Alto, CA (US)

(72) Inventors: Nimar Arora, Union City, CA (US); Kapil Garg, Bangalore (IN)

(73) Assignee: DevRev, Inc., Palo Alto, CA (US)

(21) Appl. No.: 19/189,857

(22) Filed: Apr. 25, 2025

(51) Int. Cl. G06N 20/00

(52) U.S. Cl. CPC G06N 20/00

(57) ABSTRACT

The invention provides a multi-tenant cloud-based system. The system includes a memory storing one or more processor-executable routines and a processor communicatively coupled to the memory. The processor is configured to execute one or more processor-executable routines to access customer data and machine learning (ML) computational models for a plurality of customers. The processor is further configured to train each of the ML computational models using the customer data. The processor is configured to define an async service having training parameters and one or more training routines for the ML computational models for each of the plurality of customers. The processor is configured to develop one or more nanoservices corresponding to each async service. Each of the one or more nanoservices comprises a customer-specific instance of the respective async service.

### FIELD OF INVENTION

Embodiments of the present disclosure relate to the field of cloud infrastructure, and more particularly, to techniques for training a multi-tenant cloud-based system.

### BACKGROUND

Modern SaaS platforms leverage cloud infrastructure to deliver scalable and cost-effective solutions while ensuring seamless access to customer data. A critical component of this transformation is the use of artificial intelligence (AI) and machine learning (ML) to derive insights, automate processes, and enhance user experiences.

The AI and ML models utilized by the platforms are required to be trained on a continuous basis. However, a fundamental challenge arises in training machine learning models on multi-tenant cloud platforms while ensuring data privacy and isolation across multiple customers. Unlike traditional single-tenant architectures, where each customer operates in a fully isolated environment, multi-tenant architectures inherently share underlying infrastructure, making data segregation a complex issue. Furthermore, shared infrastructure in multi-tenant architecture may increase the risk of data leakage across customers.

Existing solutions for multi-tenant model training often fall short in addressing these needs. They may either be substantially expensive to operate at scale or fail to provide adequate isolation, compromising data security and privacy. Traditional approaches also lack mechanisms for efficient event handling, state persistence, and asynchronous execution, making it difficult to maintain freshness and adaptability in model training.

There is a need for framework to support multi-tenant model training while providing data isolation and ensuring security, efficiency, and flexibility across various machine learning paradigms.

### BRIEF DESCRIPTION

The following description is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a multi-tenant cloud-based system is provided. The system includes a memory storing one or more processor-executable routines and a processor communicatively coupled to the memory. The processor is configured to execute one or more processor-executable routines to access customer data and machine learning (ML) computational models for a plurality of customers. The processor is further configured to train each of the ML computational models using the customer data. The processor is configured to define an async service having training parameters and one or more training routines for the ML computational models for each of the plurality of customers. The processor is configured to develop one or more nanoservices corresponding to each async service. Each of the one or more nanoservices comprises a customer-specific instance of the respective async service. The processor is further configured to deploy each async service for each of the plurality of customers and to execute the nanoservices associated with the respective async service to train the machine learning (ML) computational models.

According to another example embodiment, a multi-tenant cloud-based system is provided. The system includes a user interface that is configured to provide access to a plurality of customers to generate AI-based computational models. The system further includes a shared AI infrastructure framework configured to train and deploy the AI-based computational models for the plurality of customers. The framework is further configured to provide data and compute isolation across the plurality of customers. The shared AI infrastructure framework includes at least one async service defined by a user of the system. The async service having training parameters and one or more training routines for the ML computational models. The shared AI infrastructure framework further includes one or more nanoservices corresponding to each async service. Each of the one or more nanoservices comprises a customer-specific instance of the respective async service. The shared AI infrastructure framework further includes an implementation module that is configured to deploy the async services and execute the associated nanoservices to train the AI-based computational models based on a pre-determined training schedule. The system further includes an output module configured to present output events for the plurality of customers.

According to another example embodiment, a method for training ML computational models in a multi-tenant environment is provided. The method includes accessing customer data and machine learning (ML) computational models for a plurality of customers. The method further includes defining an async service having training parameters and one or more training routines for the ML computational models for each of the plurality of customers. The method further includes developing one or more nanoservices corresponding to each async service. Each of the one or more nanoservices comprises a customer-specific instance of the respective async service. The method further includes deploying each async service for each of the plurality of customers and executing the nanoservices associated with the respective async service to train the machine learning (ML) computational models.

### BRIEF DESCRIPTION OF THE DRAWINGS

The disclosure will be described and explained with additional specificity and detail with the accompanying figures in which:

FIG. 1 is a block diagram illustrating a multi-tenant cloud-based system in accordance with the embodiments of the invention;

FIG. 2 is a representation illustrating an example workflow of an event-driven architecture for nanoservice execution in a muti-tenant cloud-based system;

FIG. 3 is an illustration of an example architecture of the API service in the event-driven architecture of FIG. 2;

FIG. 4 is an illustration of an example architecture of the wakeup service in the event-driven architecture of FIG. 2;

FIG. 5 is an illustration of an example architecture of the nanoservice runner in the event-driven architecture of FIG. 2;

FIG. 6 is a flowchart illustrating the process of training ML computational models in the multi-tenant cloud-based system of FIG. 1; and

FIG. 7 is a block diagram of an embodiment of a computing device in which a multi-tenant cloud-based system, described herein, are implemented.

### DETAILED DESCRIPTION

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently, or simultaneously. In addition, the order of operations may be rearranged. The processes may be terminated when their operations are completed but may also have additional steps not included in the figures. It should also be noted that in some alternative implementations, the functions/acts/steps noted may occur out of the order noted in the figures. For example, two figures shown in succession may be executed substantially concurrently or may sometimes be executed in the reverse order, depending upon the functionality/acts involved.

Further, although the terms first, second, etc. may be used herein to describe various elements, components, regions, layers, and/or sections, it should be understood that these elements, components, regions, layers, and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between the first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

This section will describe an illustrative architecture for a multi-tenant cloud-based system designed to train machine learning (ML) computational models for plurality of customers while ensuring data and compute isolation.

Embodiments of the invention provide a cloud-based multi-tenant system that delivers robust, scalable, and fully isolated computing and training environments. Traditional multi-tenant infrastructures often struggle with cross-tenant data leakage, inefficient resource allocation, and security vulnerabilities. The architecture proposed here addresses these challenges by implementing advanced isolation techniques, real-time workload distribution, and adaptive scaling mechanisms. By integrating this intelligent multi-tenant system, businesses can achieve seamless cloud-based operations with improved security, cost-effectiveness, and adaptability.

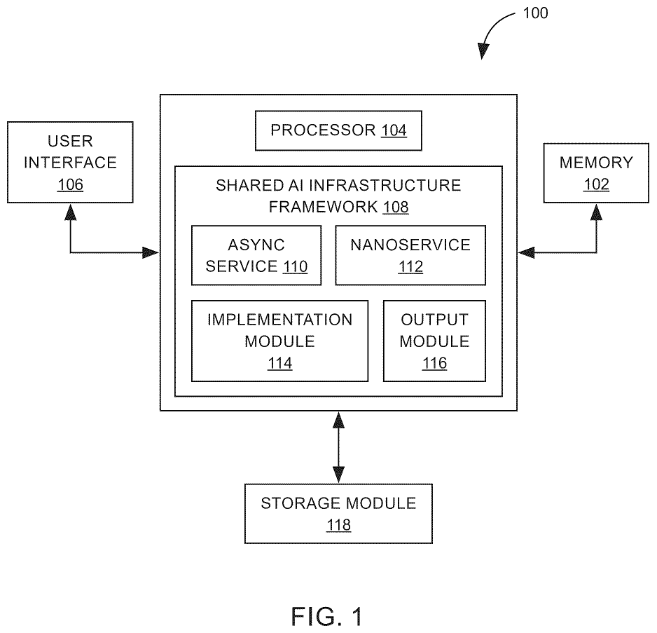

FIG. 1 illustrates a multi-tenant cloud-based system 100 in accordance with the embodiments of the invention. The system 100 is configured to train one or more Artificial Intelligence (AI)-based models including machine learning (ML) computational models for use in the system 100. The system includes a memory 102, and a processor 104 communicatively coupled to the memory 102. The memory 102 is configured to store one or more processor-executable routines. The processor 104 is configured to execute one or more processor-executable routines to manage computational workloads and model execution. The system 100 further includes a user interface 106 that is configured to provide access to a plurality of customers to generate the AI-based computational models for their requirements.

The processor 104 is configured to access customer data and machine learning (ML) computational models for a plurality of customers. In the example embodiment, the system 100 includes a shared AI infrastructure framework 108. The shared AI infrastructure framework 108 is configured to train and deploy the ML computational models for the plurality of customers. The shared AI infrastructure framework 108 is further configured to facilitate data and compute isolation among the plurality of customers in the multi-tenant environment. For instance, the shared AI infrastructure framework 108 is configured to use a partitioned structure for data and compute isolation across the plurality of customers.

In operation, the processor 104 is configured to access customer data and ML computational models for the plurality of customers and train each of the ML computational models using the customer data.

The shared AI infrastructure framework 108 includes at least one asynchronous (async) service 110, one or more nanoservices 112 and an implementation module 114 to train, deploy and manage machine learning (ML) models via the shared infrastructure framework 108 while maintaining data and compute isolation. The async service 110 may be defined by a user of the system 100 and includes training parameters and one or more training routines for ML computational models. For instance, training parameters configured by the user may include, but not limited to, learning rate, batch size, optimizer type, model architecture (e.g., CNN, RNN, Transformer), hyperparameters (e.g., dropout rate, number of layers), and data pre-processing configurations. The training parameters can be specified by individual users/customers and may be adjusted from time-to-time.

The async services 110 for each customer includes schema of the respective service 110, one or more events associated with the training model and output events. The schema of the async service 110 may define the structure, configuration, and execution logic, along with metadata corresponding to the customer's training parameters, data sources, model type, and other computational requirements. The schema functions as a blueprint that determines how the async service 110 will function for the individual customer.

The one or more events linked to the training model correspond to different phases of the machine learning (ML) lifecycle such as data ingestion, preprocessing, training initiation, model validation, and retraining triggers. These events facilitate monitoring and orchestrating the ML workflow, allowing the system to dynamically manage and track the execution of each process in real-time. Once the training model completes a cycle, an output module 116 is configured to present output events for the plurality of customers. The output events may include results such as trained model data, evaluation metrics, performance reports, or deployment triggers.

The shared AI infrastructure framework 108 further includes the one or more nanoservices 112 corresponding to each async service 110. Each of the one or more nanoservices 112 includes a customer-specific instance of the respective async service 110 to facilitate the independent execution of machine learning (ML) training processes to train the ML computational models. Each nanoservice 112 is uniquely configured by the processor 104 based on the training parameters, data sources, and computational requirements of the customer to ensure precise and efficient model training. The shared AI infrastructure framework 108 is configured to provide data and compute isolation by selective execution of the nanoservices 112 for each respective customer.

In one embodiment, the processor 104 is configured to create each nanoservice 112 using a remote procedure call (RPC) for seamless initialisation and execution of each nanoservice 112 on the shared AI infrastructure framework 108. The processor 104 is further configured to implement each of the one or more nanoservices 112 associated with the respective async service 110, based on configuration parameters and a run frequency of the respective nanoservice 112.

The processor 104 is further configured to perform an initial set-up for each nanoservice 112, using training parameters, datasets, and computational resources. The implementation module 114 is configured to execute the nanoservices 112 associated with the respective async service 110 via the shared infrastructure framework 108 to train the ML computational model. The processor 104 is further configured to update a state of the nanoservice 112 to reflect its progress, manage dependencies and generate output events. The output module 116 is configured to present the output events, such as trained model artifacts, evaluation metrics, and inference results. Additionally, the processor 104 is configured to store data of each nanoservice 112 in a storage module 118 during execution to ensure intermediate and final training datasets are available for future retraining, optimization, and validation.

The processor 104 is configured to deploy each async service 110 independently via the implementation module 114, to ensure isolated execution of ML training routines for the plurality of customers without interference. To achieve this, the processor 104 is configured to instantiate dedicated execution environments for each async service 110, allocating necessary compute resources such as CPUs, GPUs, or TPUs based on the specific training parameters defined by the customer. The async services 110 for the plurality of customers are implemented via the implementation module 114 in the shared infrastructure framework 108.

In another example embodiment, the processor 104 is configured to train ML computational models based on a pre-determined training cycle, which is configurable by the user of the system via the user interface 106. This allows flexibility in defining the training frequency based on specific business needs, data availability, or performance requirements. The processor 104 is further configured to ensure that models are periodically trained at pre-defined wakeup intervals, optimizing performance while maintaining data and compute isolation for each customer. If the model is due for training within the scheduled interval, the processor 104 is configured to automatically initiate the retraining process to keep the model accurate and up to date.

Furthermore, the processor 104 is configured to facilitate access-based sharing of ML computational models and data via the shared infrastructure framework 108, allowing authorised users to securely interact with and utilise trained ML models.

The user interface 106 is configured to allow users to define training parameters, set execution schedules, and monitor model performance through a centralised dashboard. The user interface 106 further enables customers to interact with the shared AI infrastructure framework 108 to create async services 110, review associated nanoservices 112, and customize model training workflows based on their specific requirements. Additionally, the user interface 106 is configured to present output events, helping users track model updates, performance metrics, and retraining schedules. By integrating access control mechanisms, the user interface 106 ensures that users can securely manage their own models while leveraging the shared infrastructure for efficient resource utilisation. This streamlined approach ensures efficient model lifecycle management in a multi-tenant environment.

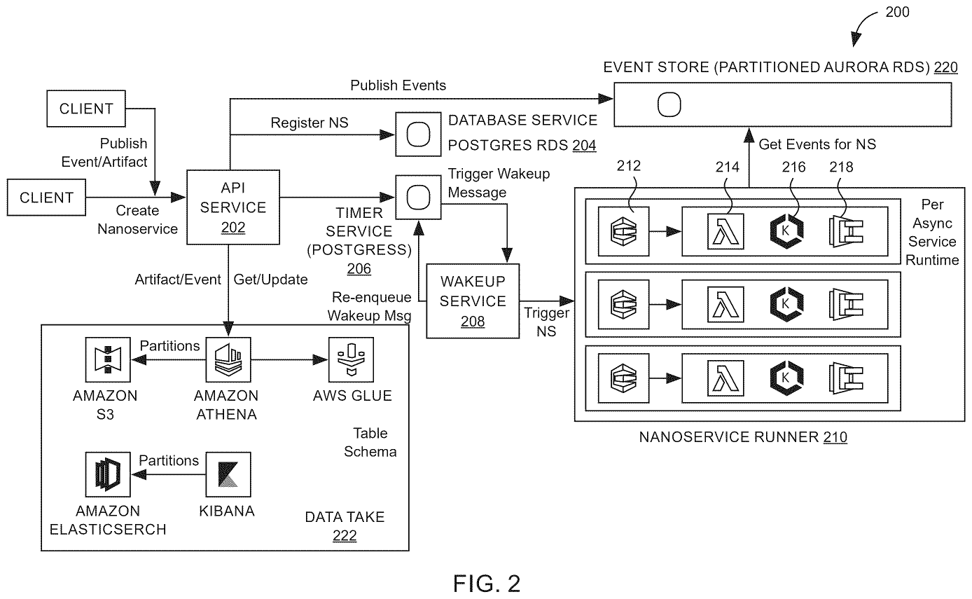

FIG. 2 is an example workflow 200 of an event-driven architecture for nanoservice 112 execution in the multi-tenant cloud-based system 100 of FIG. 1. As described above, the system 100 is configured to train the ML computational model using one or more nanoservices 112 of the respective async service 110. The system 100 utilizes API services 202, wakeup services 208, a nanoservice runner 210 and a data lake 222 for seamless execution of one or more nanoservices 112. In operation, a user/client of the system 100 sends a request (e.g., via an HTTP API call) to the API service 202 via the user interface 106 to create the one or more nanoservices 112. The API service 202 is configured to validate the request and process the necessary configuration provided by the client to register nanoservices 112 in a database service (e.g., Amazon RDS (PostgreSQL)) 204 to maintain a record of nanoservices 112 and configurations.

Once registered, the API service 202 enqueues a wakeup message using a timer service 206 (backed by PostgreSQL RDS). The timer service 206 schedules and manages the timing for wakeup messages, ensuring nanoservices 112 are activated at the appropriate times. Once the predefined timer condition is met, the timer service retrieves the wakeup event from the timer service 206 and triggers the wakeup service 208 to initiate the nanoservice execution. This mechanism ensures efficient resource utilisation and timely execution of nanoservices 112 based on predefined schedules.

The nanoservice runner 210 further initiates the nanoservice 112 execution by running it within a containerized, async service runtime, where each service execution is managed independently. For efficient execution of ML models, nanoservices 112, and async services 110, the system 100 leverages a cloud computing platform such as Amazon Web Services (AWS) for dynamic workload orchestration. For example, an Amazon Event Bridge 212 functions as the central event bus, capturing and routing events to trigger processing components. Further, AWS Lambda 214 may provide a serverless execution environment for lightweight, event-driven tasks, while Amazon Elastic Kubernetes Service (EKS) 216 orchestrates containerized workloads for scalable execution. Additionally, Amazon Elastic Container Service (ECS) 218 supports containerized deployments of the models. Other suitable platforms and respective services may be envisaged for managing and deploying the async services and executing the nanoservices 112.

Additionally, the system 100 stores relevant events for the nanoservice 112 within an event store 220. The event store 220 is implemented using Amazon Aurora RDS with a partitioned structure to efficiently store and manage events. The partitioned structure ensures data and compute isolation across the plurality of customers, preventing data overlap and maintaining tenant-specific event processing.

To ensure continuous execution of nanoservices 112, the wakeup service 208 re-enqueues the wakeup message, allowing the nanoservice 112 to be reactivated periodically over pre-determined wakeup intervals. Once the nanoservice 112 execution is completed, the system 100 is configured to publish the generated events and artifacts back to the API Service 202, which then publishes these events to the event store 220. The artifacts and events are also stored and updated within the data lake architecture 222.

For data storage and analytics, the system 100 integrates various AWS services. For example, Amazon S3 serves as the primary storage layer where raw and processed data is stored. Amazon Athena may be used to enable interactive querying of this data by leveraging a schema-on-read approach. AWS Glue acts as the data catalogue and ETL (Extract, Transform, Load) service, providing schema definitions and metadata management to structure data for efficient querying in Amazon Athena.

Additionally, Amazon Elasticsearch is used for real-time search and analytics, with Kibana serving as the visualization and dashboarding tool. The data is partitioned for optimized querying and indexing, ensuring efficient retrieval and analysis across both structured and unstructured datasets. This architecture supports scalable, serverless data processing and real-time insights.

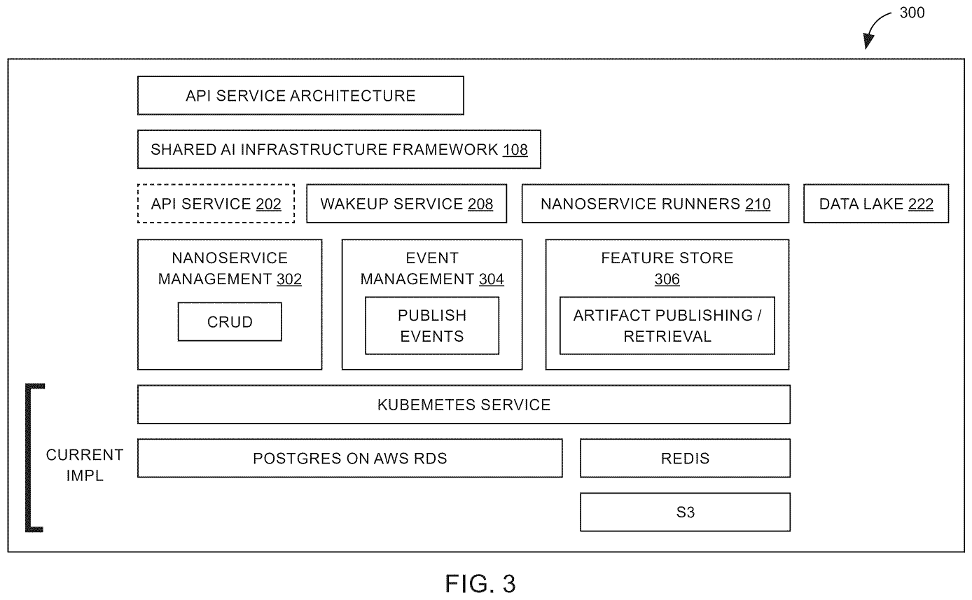

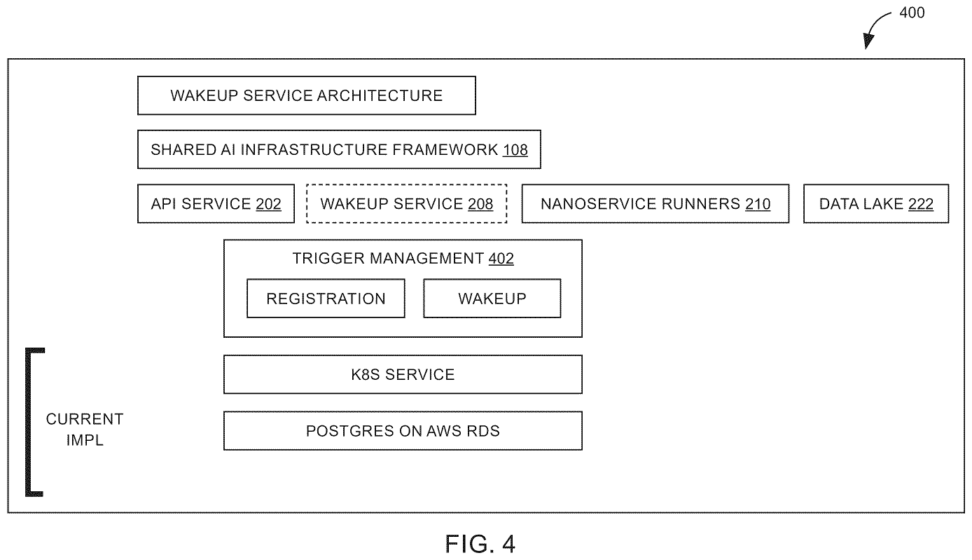

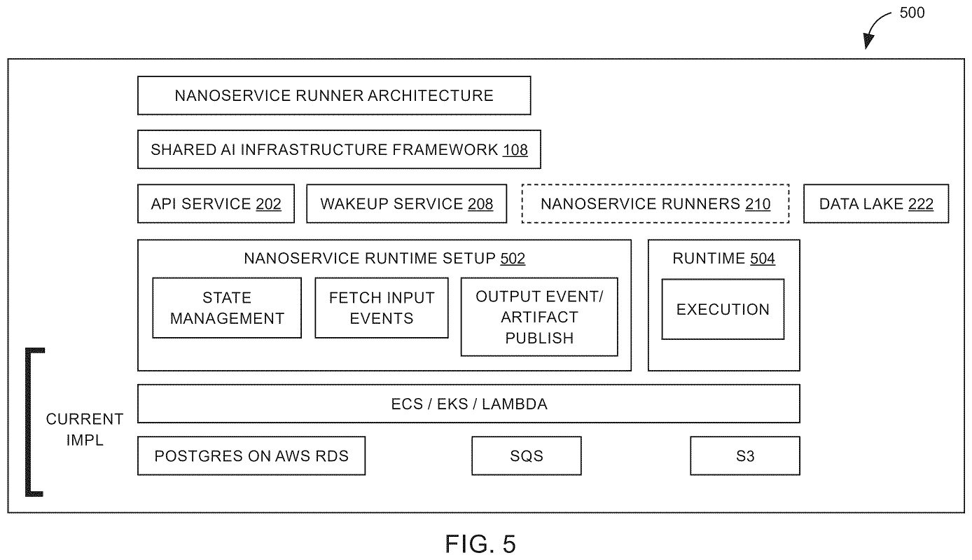

The multi-tenant cloud-based system 100 is highly scalable, leveraging cloud computing platforms such as AWS services including Lambda, Kubernetes, and Event-Driven Processing to manage per-service runtimes dynamically. Each nanoservice 112 execution runs in its own containerized environment, ensuring isolation and efficient resource utilisation. This design supports event-driven automation, serverless computing, and real-time analytics, making it suitable for multi-tenant AI and data processing applications. The detailed architecture of the API service 202, the wakeup service 208, and the nanoservice runner 210 will be described with reference to FIG. 3, FIG. 4, and FIG. 5.

FIG. 3 illustrates an example architecture 300 of the API service 202 in the event-driven architecture 200 of FIG. 2, in accordance with some embodiments of the disclosure. The API service 202 of the architecture 200 is configured to facilitate communication between the processor 104 and the user interface 106 to orchestrate service execution. The API service 202 includes modules such as nanoservice management 302, event management 304, and feature store 306 for nanoservice execution and data handling.

The nanoservice management module 302 is configured to deploy and manage nanoservices 112 using CRUD (Create, Read, Update, Delete) operations. The event management 304 is configured to facilitate the event-driven workflow by publishing and handling events that trigger nanoservice 112 execution, ensuring dynamic and responsive automation. The feature store 306 is configured to function as a centralized repository for publishing and retrieving artifacts, that may include machine learning models, execution results, or reusable data assets.

In this example, the API service 202 is supported by Kubernetes for orchestration, Postgres on AWS RDS for structured data storage, Redis for caching, and S3 for scalable object storage, ensuring seamless and efficient execution of nanoservices 112 within the system 100. The API service 202 is configured to orchestrate nanoservices 112 and enables real-time execution, data persistence, and event-driven automation in the multi-tenant architecture.

FIG. 4 illustrates an example architecture 400 of the wakeup service 208 in the event-driven architecture 200 for nanoservice 112 execution of FIG. 2, in accordance with some embodiments of the disclosure. The wakeup service 208 of the architecture 200 is configured to manage the activation and execution of nanoservices 112 within the shared AI infrastructure framework 108. The wakeup service 208 is configured for service orchestration by ensuring that nanoservices 112 are triggered based on predefined conditions, external API requests, or scheduled events.

The wakeup service 208 includes trigger management 402 that is configured to handle the process of registering nanoservices 112 and managing their execution triggers. The registration functionality ensures that nanoservices 112 are indexed with metadata, dependencies, and execution parameters, allowing for efficient tracking and invocation. The wakeup functionality is further configured to activate nanoservices 112 when execution criteria are met, ensuring seamless orchestration and event-driven execution within the system 100.

The wakeup service 208 is also supported by Kubernetes (K8s) for container orchestration and Postgres on AWS RDS for structured data storage, ensuring high availability, scalability, and optimized resource management in the multi-tenant environment. By effectively handling nanoservice 112 execution triggers, the wakeup service 208 enhances system responsiveness, automation, and workload distribution.

FIG. 5 illustrates an example architecture 500 of the nanoservice runner 210 in the event-driven architecture 200 of FIG. 2. The nanoservice runner 210 of the architecture 200 is configured to handle the execution of nanoservices 112 within the system 100. The nanoservice runner 210 ensures seamless processing of nanoservices 112 by managing the lifecycle of nanoservices 112, from input event fetching to execution and result publication. The nanoservice runner 210 is configured to provide the necessary runtime environment to enable efficient, event-driven automation across multiple tenants.

In this example, a nanoservice runtime setup 502 is configured to orchestrate nanoservice 112 execution using key functionalities. For example, a state management functionality ensures that nanoservice 112 execution maintains consistency, tracking progress and handling retries in case of failures. Moreover, a fetch input events functionality retrieves relevant event data that serves as input for nanoservice 112 execution, to facilitate accurate and context-aware processing. Additionally, an output event/artifact publish functionality enables nanoservices 112 to generate and distribute execution results, artifacts, or logs to the event store 220.

Further, runtime execution 504 component manages the actual execution of nanoservices 112, leveraging compute environments such as ECS (Elastic Container Service), EKS (Elastic Kubernetes Service), or AWS Lambda based on workload requirements. The execution results can be processed asynchronously via SQS (Simple Queue Service) for optimized task handling and distributed processing. The architecture 500 is configured to integrate with Postgres on AWS RDS for structured data storage and S3 for scalable object storage, ensuring persistence and high availability of execution results and artifacts.

By efficiently managing nanoservice 112 execution, state tracking, and event-driven processing, the nanoservice runners 210 enable scalable, resilient, and cost-effective automation.

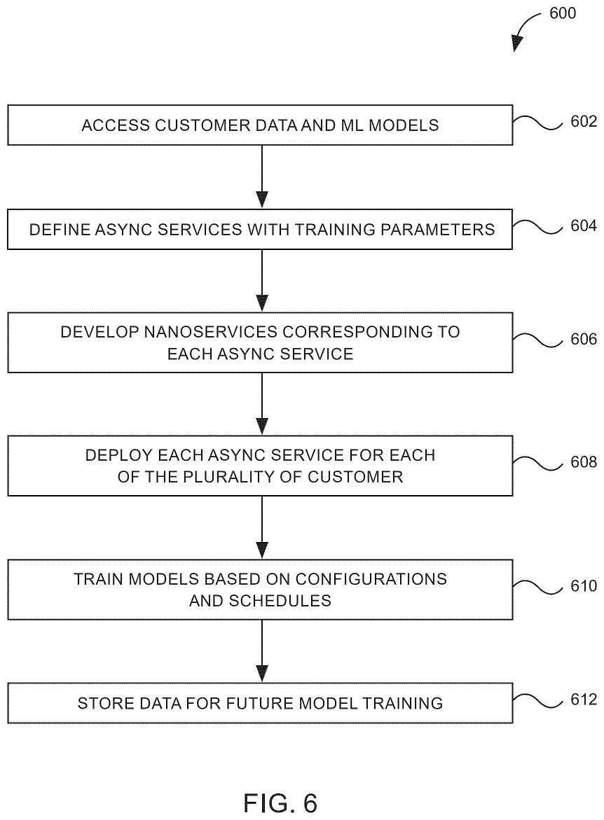

FIG. 6 is a flowchart 600 illustrating the process of training ML computational models in the multi-tenant cloud-based system 100 of FIG. 1. At block 602, the system accesses customer data and machine learning (ML) computational models for a plurality of customers via the user interface. The system uses the shared AI infrastructure framework to train and deploy the ML computational models for the plurality of customers using customer data.

At block 604, each of the plurality of customers may define at least one async service that includes training parameters and one or more training routines for ML computational models. For instance, training parameters configured by the customer may include, but not limited to, learning rate, batch size, optimizer type, model architecture (e.g., CNN, RNN, Transformer), hyperparameters (e.g., dropout rate, number of layers), and data pre-processing configurations. The training parameters can be specified by individual customers and dynamically adjusted.

At block 606, the system develops one or more nanoservices corresponding to each async service. Each of the one or more nanoservices includes a customer-specific instance of the respective async service to facilitate the independent execution of machine learning (ML) training processes to train ML computational models. For instance, the remote procedure call (RPC) technique is used to create each nanoservice. Each nanoservice is uniquely configured by the system based on the training parameters, data sources, and computational requirements of the customer to ensure precise and efficient model training.

At block 608, the implementation module of the system deploys each async service for each of the plurality of customers by executing the nanoservices associated with the respective async service to train the ML computational models. Based on the configurations and schedules provided by the customer, the system efficiently trains the ML computational model (block 610). At 612, the system stores the data of each nanoservice in the storage module during execution to ensure intermediate and final training datasets are preserved for future retraining, optimization, or validation.

Moreover, the system facilitates data and compute isolation among the plurality of customers in the multi-tenant environment. For instance, the shared AI infrastructure framework uses a partitioned structure for data and compute isolation across the plurality of customers. The system may independently develop the models for each customer or may customize the models based on customers' requirements. By independently developing and customizing models, the system ensures greater flexibility and personalization while maintaining data and compute isolation.

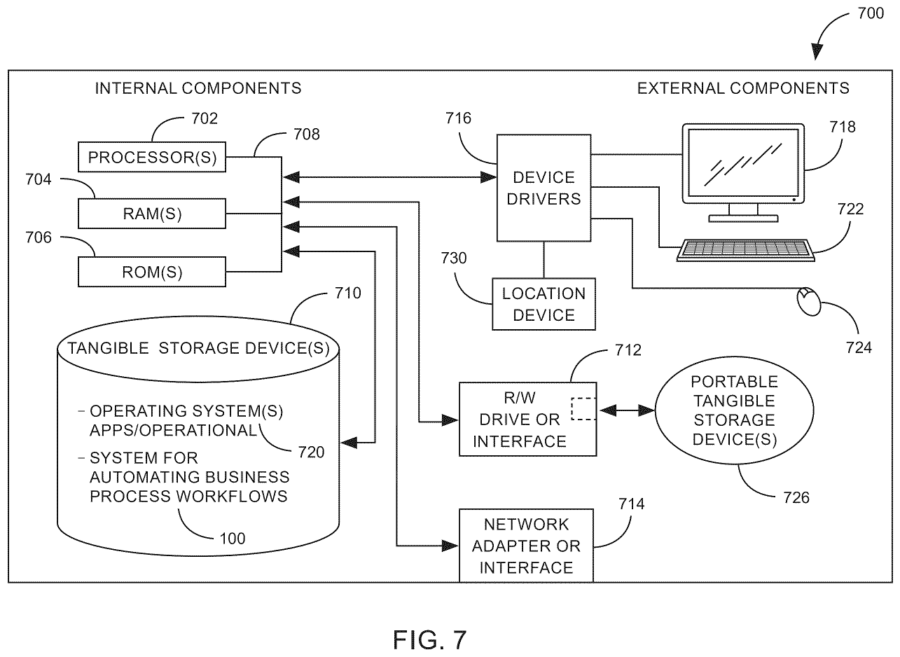

The multi-tenant cloud-based system 100 described herein, are implemented in computing devices. One example of a computing device 700 is described below in FIG. 7. The computing device 700 includes one or more processor(s) 702, one or more computer-readable RAMs 704, and one or more computer-readable ROMs 706 on one or more buses 708. Further, the computing device 700 includes a tangible storage device 710 that may be used to execute operating systems 720 and the multi-tenant cloud-based system 100. The various modules of the multi-tenant cloud-based system 100 may be stored in the tangible storage device 710. Both, the operating systems 720 and the multi-tenant cloud-based system 100 are executed by one or more processor(s) 702 via one or more respective RAMs 704 (which typically include cache memory). The execution of the operating systems 720 and/or the multi-tenant cloud-based system 100 by one or more processor(s) 702, configures the one or more processor(s) 702 as a special purpose processor configured to carry out the functionalities of the operation systems 720 and/or the multi-tenant cloud-based system 100 as described above.

Examples of tangible storage devices 710 include semiconductor storage devices such as ROM, EPROM, flash memory, or any other computer-readable tangible storage device that may store a computer program and digital information.

The computing device 700 also includes an R/W drive or interface 714 to read from and write to one or more portable computer-readable tangible storage devices 728, such as a CD-ROM, DVD, memory stick, or semiconductor storage device. Further, network adapters or interfaces 712 such as TCP/IP adapter cards, wireless Wi-Fi interface cards, or 3G or 4G wireless interface cards, or other wired or wireless communication links are also included in computing devices.

In one example embodiment, the multi-tenant cloud-based system 100 may be stored in the tangible storage device 710 and may be downloaded from an external computer via a network (for example, the Internet, a local area network, or other, wide area network) and network adapter or interface 712.

Computing device 700 further includes device drivers 716 to interface with input and output devices. The input and output devices may include a computer display monitor 718, a keyboard 722, a keypad, a touch screen, a computer mouse 724, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or its uses. The broad teachings of the disclosure may be implemented in a variety of forms. Therefore, while this disclosure includes particular examples, the true scope of the disclosure should not be so limited since other modifications will become apparent upon a study of the drawings, and the specification. It should be understood that one or more steps within a method may be executed in different order (or concurrently) without altering the principles of the present disclosure. Further, although each of the example embodiments is described above as having certain features, any one or more of those features described with respect to an example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer-readable medium, and tangible computer program product. For example, the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple pl that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device's main body or a removable medium arranged so that it may be separated from the computer device's main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include but are not limited to, rewriteable non-volatile memory devices (including, for example, flash memory devices, erasable programmable read-only memory devices, or mask read-only memory devices), volatile memory devices (including, for example, static random access memory devices or a dynamic random access memory devices), magnetic storage media (including, for example, an analog or digital magnetic tape or a hard disk drive), and optical storage media (including, for example, a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

We claim:

1. A multi-tenant cloud-based system, wherein the system comprises:
a memory storing one or more processor-executable routines; and
a processor communicatively coupled to the memory, the processor configured to execute the one or more processor-executable routines to:
access customer data and machine learning (ML) computational models for a plurality of customers;
train each of the ML computational models using the customer data, wherein the processor is further configured to:
define an async service having training parameters and one or more training routines for the ML computational models for each of the plurality of customers;
develop one or more nanoservices corresponding to each async service, wherein each of the one or more nanoservices comprises a customer-specific instance of the respective async service; and
deploy each async service for each of the plurality of customers; wherein the processor is further configured to execute the nanoservices associated with the respective async service to train the machine learning (ML) computational models.

2. The multi-tenant cloud-based system of claim 1, wherein the processor is further configured to facilitate data isolation among the plurality of customers while training the ML computational models.

3. The multi-tenant cloud-based system of claim 1, wherein the processor is configured to train the ML computational models based on a pre-determined training cycle, wherein the training cycle is configurable by a user of the system.

4. The multi-tenant cloud-based system of claim 1, wherein the processor is configured to deploy each async service independently and wherein the async services for the plurality of customers are implemented via a shared infrastructure platform.

5. The multi-tenant cloud-based system of claim 4, wherein the async service for each customer comprises a schema of the respective service, one or more events associated with the training model and output events.

6. The multi-tenant cloud-based system of claim 1, wherein the processor is configured to create each nanoservice via a remote procedure call (RPC).

7. The multi-tenant cloud-based system of claim 1, wherein the processor is configured to implement each of one or more nanoservices based upon configuration parameters and a run frequency of the respective nanoservice.

8. The multi-tenant cloud-based system of claim 7, wherein the processor is further configured to:
perform an initial set-up of each nanoservice;
execute the nanoservice via the shared infrastructure platform to train the ML computational model;
update a state of the nanoservice and generate output events; and
store data during execution of the nanoservice, wherein the stored data is utilised for model training.

9. The multi-tenant cloud-based system of claim 7, wherein the processor is further configured to:
determine if the model is required to be retrained over pre-determined wakeup intervals; and
retrain the model if it is determined that the model is due for training.

10. The multi-tenant cloud-based system of claim 7, wherein the processor is further configured to facilitate access-based sharing of the computational models and data via the shared infrastructure platform.

11. A multi-tenant cloud-based system, wherein the system comprises:
a user interface configured to provide access to a plurality of customers to generate AI-based computational models;
a shared AI infrastructure framework configured to train and deploy the AI-based computational models for the plurality of customers, wherein the framework is further configured to provide data and compute isolation across the plurality of customers; and wherein the shared AI infrastructure framework comprises:
at least one async service defined by a user of the system, the async service having training parameters and one or more training routines for the ML computational models,
one or more nanoservices corresponding to each async service, wherein each of the one or more nanoservices comprises a customer-specific instance of the respective async service; and
an implementation module configured to deploy the async services and execute the associated nanoservices to train the AI-based computational models based on a pre-determined training schedule; and
an output module configured to present output events for the plurality of customers.

12. The multi-tenant cloud-based system of claim 11, wherein the async service for each customer comprises schema of the respective service, one or more events associated with the training model and output events.

13. The multi-tenant cloud-based system of claim 11, wherein the shared AI infrastructure framework is configured to provide data and compute isolation by selective execution of the nanoservices for respective customers.

14. The multi-tenant cloud-based system of claim 13, wherein the shared AI infrastructure framework is configured to use a partitioned structure for data and compute isolation across the plurality of customers.

15. The multi-tenant cloud-based system of claim 11, wherein the shared AI infrastructure framework is further configured to:
perform an initial set-up of each nanoservice;
execute the nanoservice to train the ML computational model;
update a state of the nanoservice and generate output events; and
store data during execution of the nanoservice, wherein the stored data is utilised for model training.

16. The multi-tenant cloud-based system of claim 11, wherein the shared AI infrastructure framework is configured to periodically train the models over pre-determined wakeup intervals.

17. A method for training ML computational models in a multi-tenant environment, the method comprising:
accessing customer data and machine learning (ML) computational models for a plurality of customers;
defining an async service having training parameters and one or more training routines for the ML computational models for each of the plurality of customers;
developing one or more nanoservices corresponding to each async service, wherein each of the one or more nanoservices comprises a customer-specific instance of the respective async service; and
deploying each async service for each of the plurality of customers and executing the nanoservices associated with the respective async service to train the machine learning (ML) computational models.

18. The method of claim 17, wherein developing the nanoservices comprises generating a customer-specific instance of the respective async service.

19. The method of claim 17, further comprising facilitating data and compute isolation across the plurality of customers via a partitioned structure.

20. The method of claim 17, further comprising independently developing the models and customizing the models based on customer requirements for each of the plurality of customers.
